(19) United States
(12) Patent Application Publication
(10) Pub. No.: US 2020/0331000 A1
(43) Pub. Date: Oct. 22, 2020

(54) ROTOR CHAMBER FIN FOR CHIPPER SHREDDER

(71) Applicant: Country Home Products, Inc., Vergennes, VT (US)

(72) Inventor: Scott Silberstein, South Burlington, VT (US)

(73) Assignee: Country Home Products, Inc., Vergennes, VT (US)

(21) Appl. No.: 16/851,905

(22) Filed: Apr. 17, 2020

Related U.S. Application Data
(60) Provisional application No. 62/836,500, filed on Apr. 19, 2019.

(51) Int. Cl. B02C 18/14

(52) U.S. Cl. CPC B02C 18/145; B02C 18/18

(57) ABSTRACT

A mobile chipper shredder includes a removable fin plate positioned within the rotor chamber. The removable fin plate includes a main body that has an arcuate shape and a plurality of fins that extend toward a rotor assembly from the main body. The fins are spaced on the main body so as to not interfere with paths of travel of a plurality free-swinging shredding hammers of the rotor assembly within the rotor chamber. The plurality of fins radially overlap at least one path of travel of the plurality of free-swinging shredding hammers.

### CROSS REFERENCE TO RELATED APPLICATIONS

This application claims priority to U.S. Provisional Application No. 62/836,500, filed on Apr. 19, 2019, entitled ROTOR CHAMBER FIN FOR CHIPPER SHREDDER, the disclosure of which is hereby incorporated by reference in its entirety.

### BACKGROUND

Chipper shredder machines are used to reduce debris, such as yard waste. Chipper shredders can include a shredding hopper and a chipping chute. The shredding hopper can be used for receiving leaves and other like material for shredding, and the chipping chute can be used to receiving branches or the like for chipping. Chipper shredders use a rotating rotor assembly to both shred and chip debris introduced at the shredding hopper and at the chipping chute, respectively. The rotor assembly rotates within a rotor chamber to reduce debris before outputting reduced debris through a screen to a discharge area outside of the chipper shredder. However, depending on the type of debris introduced to the rotor chamber, the rotor assembly and rotor chamber can become jammed and/or clogged, leading to reduced productivity of the chipper shredder and potential damage to the machine. Specifically, debris can build up at the outer extents of the rotor chamber, leading to reduced production of the chipper shredder machine.

Therefore, improvements in chipper shredders are needed.

### SUMMARY

The present disclosure relates generally to chipper shredder machines. In one possible configuration, and by non-limiting example, a chipper shredder includes a plurality of fins positioned on a plate at the interior of a rotor chamber that houses a rotating rotor assembly.

In one aspect of the present disclosure, a mobile chipper shredder is disclosed. The mobile chipper shredder includes a frame and wheels mounted to the frame. The mobile chipper shredder includes a motor mounted to the frame. The mobile chipper shredder includes a chipping inlet for receiving debris to be chipped and a shredding inlet for receiving debris to be shredded. The mobile chipper shredder includes a rotor chamber in communication with the chipping inlet and the shredding inlet. The rotor chamber rotationally houses a rotor assembly powered by the motor. The rotor assembly includes a chipping disc for receiving debris from the chipping inlet, and a plurality of free-swinging shredding hammers. Each of the plurality of free-swinging shredding hammers has a path of travel as the rotor assembly rotates. The rotor chamber is defined by an inner wall and a removable plate. The removable plate includes a main body that has an arcuate shape a plurality of fins that extend toward the rotor assembly from the main body. The fins are spaced on the main body so as to not interfere with the paths of travel of the free-swinging shredding hammers. The plurality of fins radially overlap at least one path of travel of the plurality of free-swinging shredding hammers. The rotor chamber is defined an arcuate screen that defines a plurality of apertures. The apertures are sized and shaped to allow debris processed in the rotor chamber to pass therethrough. The mobile chipper shredder includes an outlet for receiving processed debris through the screen from the rotor chamber. The outlet is configured to deliver the processed debris to a discharge area external of the chipper shredder.

In another aspect of the present disclosure, a removable fin plate for use in a rotor chamber of a chipper shredder machine is disclosed. The removable fin plate includes a main body that has an arcuate shape. The main body is configured to form a portion of the rotor chamber. The removable fin plate includes a plurality of fins fixed to, and extending away from, the main body. The fins are spaced on the main body and each fin has a ramped leading edge leading to a fin point.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a right side perspective view of a chipper shredder, according to one example of the present disclosure.

FIG. 2 is a left side perspective view of the chipper shredder of FIG. 1.

FIG. 3 is a right side view of the chipper shredder of FIG. 1.

FIG. 4 is a rear side view of the chipper shredder of FIG. 1.

FIG. 5 is an exploded view of the chipper shredder of FIG. 1.

FIG. 6 is a perspective view of a rotor assembly of the chipper shredder of FIG. 1.

FIG. 7 is a left side perspective view of a rotor chamber with a rotor assembly of the chipper shredder of FIG. 1.

FIG. 8 is a right side perspective view of the rotor chamber of FIG. 7.

FIG. 9 is a left side view of the rotor chamber of FIG. 7.

FIG. 10 is a left side perspective view of a portion of a first fin plate of the rotor chamber with the rotor assembly of the chipper shredder of FIG. 1.

FIG. 11 is an axial view of a portion of the first fin plate of FIG. 10.

FIG. 12 is a perspective view of a first fin plate, according to one example of the present disclosure.

FIG. 13 is a side view of a fin of the first fin plate of FIG. 12.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

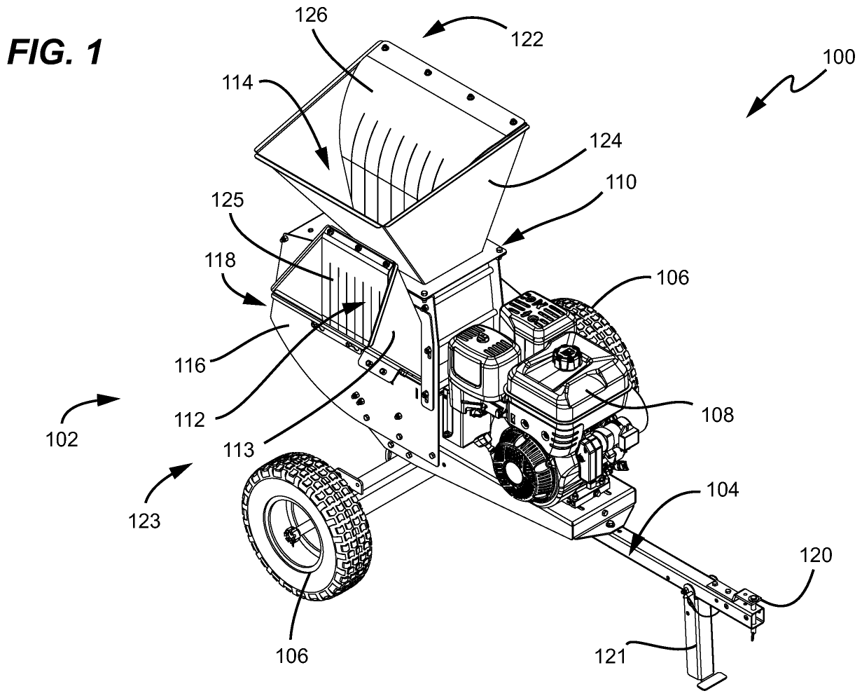

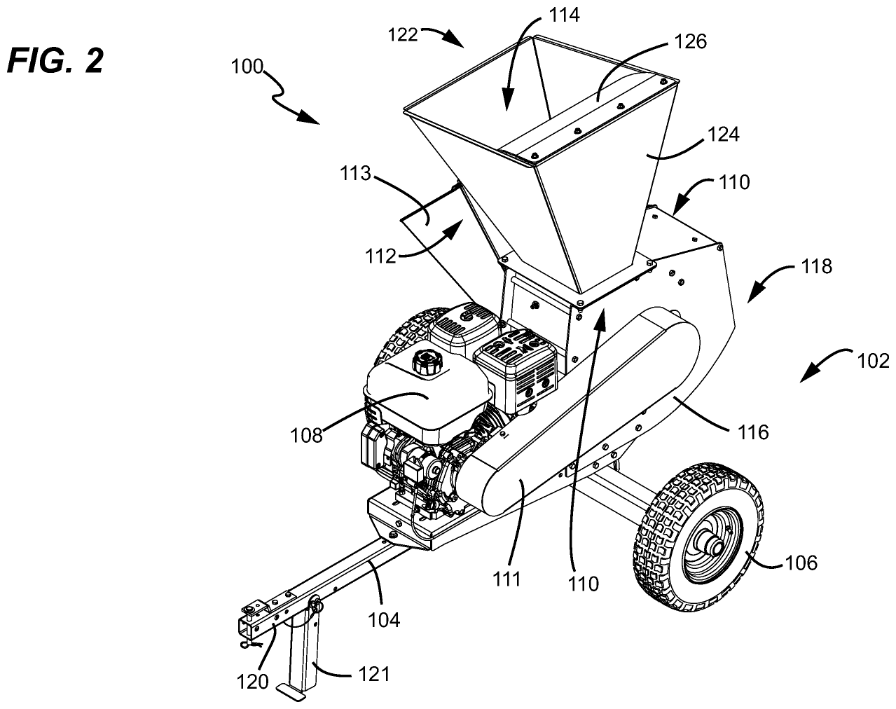

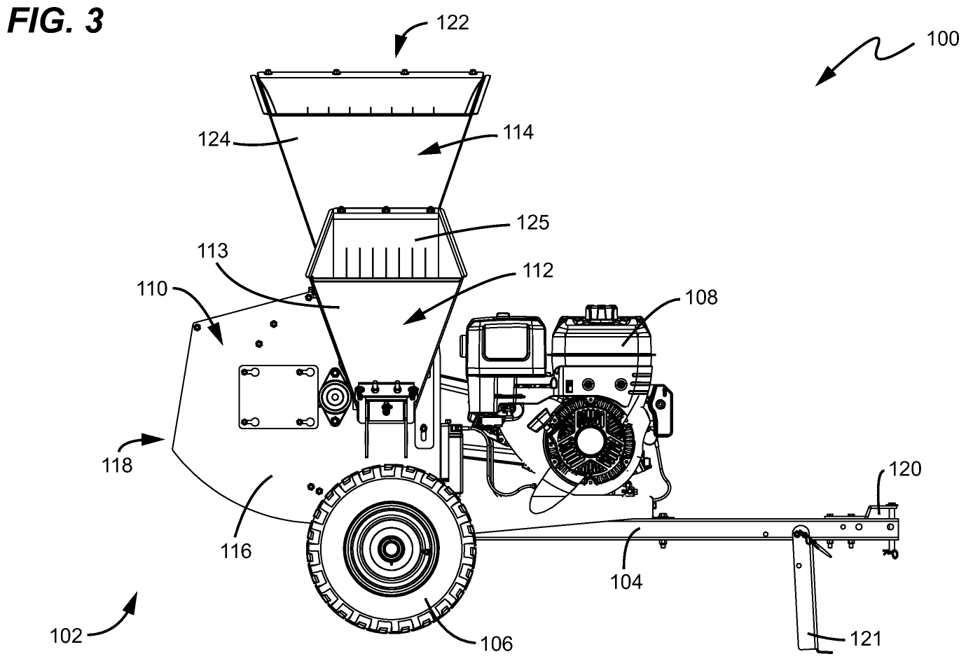

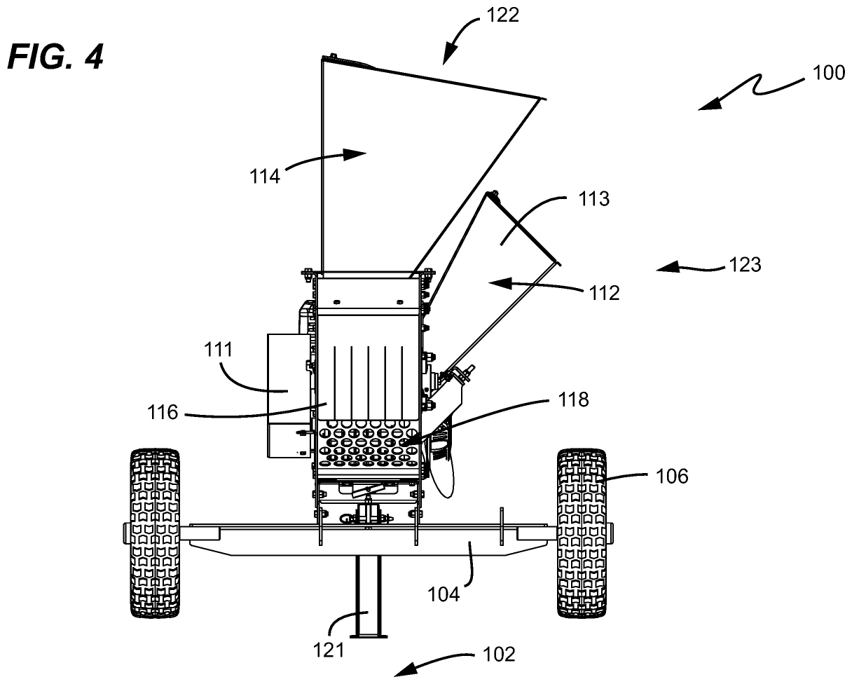

FIGS. 1-2 show perspective views of chipper shredder machine 100 according to one example of the present disclosure. FIG. 3 shows a side view of the chipper shredder machine 100. FIG. 4 shows a rear view of the chipper shredder machine 100.

The chipper shredder machine 100 is configured to receive debris, such as yard waste, and output both chipped and shredded debris to a discharge area 102 so that the debris can be managed more easily.

The chipper shredder 100 includes a frame 104 that includes wheels 106, a motor 108 mounted to the frame 104, and a housing 110. The housing 110 includes a chipping inlet 112, a shredding inlet 114, a rotor chamber housing 116, and an outlet 118.

The frame 104 supports the other components of the chipper shredder 100 on the wheels 106. As depicted, the frame 104 includes a plurality of wheels 106. In some examples, the frame 104 includes three wheels 106. In other examples, the frame 104 can include tracks instead of wheels. In some examples, the frame 104 includes a hitch 120 that can be connected to a tow vehicle so that the chipper shredder 100 can be towed. In some examples, the frame 104 can include a support 121 adjacent the hitch 120 to aid in supporting the frame 104 when the hitch 120 is not connected to a tow vehicle.

The motor 108 provides power to the chipper shredder 100. In some examples, the motor 108 is an internal combustion engine. In other examples, the motor 108 is an electric motor. In other examples still, the motor 108 is a hybrid electric engine.

The housing 110 at least partially contains the internal components of the chipper shredder 100.

The chipping inlet 112 is configured to receive debris to be chipped by the chipper shredder 100. In some examples, the chipping inlet 112 is at a side 123 of the chipper shredder 100. An operator may load debris to be chipped such as branches that have a maximum diameter via chipping inlet 112. In some examples, the chipping inlet 112 includes chipper chute 113. In some examples, the chipping inlet 112 provides access to a chipping disc including a chipping knife, which will be discussed in more detail herein. In some examples, the chipping inlet 112 includes a chipping deflector 125 that aids in preventing debris from being inadvertently expelled from the chipping inlet 112.

The shredding inlet 114 is configured to receive debris to be shredded by the chipper shredder 100. An operator may load debris to be shredded via shredding inlet 114 such as, but not be limited to, leaves, brush, small branches, etc. The shredding inlet 114 is positioned at a top side 122 of the chipper shredder 100 and includes a hopper 124 and shredding deflector 126 to aid in preventing debris from being inadvertently expelled from the hopper 124.

In use, an operator would chose to insert larger debris, such as large branches, into the chipping inlet 112 to ensure proper processing by the chipper shredder 100, while the operator would insert smaller debris into the shredding inlet 114.

The rotor chamber housing 116 encloses at least a portion of the chipper shredder 100 where debris delivered via the inlets 112, 114 is processed. As shown in FIG. 2, the housing 110 also includes a drive cover 111 that is configured to shield a transmission element such as a chain, a belt, a gear assembly, or the like, that travels from the motor 108 to the rotor chamber housing 116.

The outlet 118 is configured to receive processed debris and deliver the processed debris to the discharge area 102, external the chipper shredder 100. In some examples, the outlet 118 is configured to deliver processed debris to the discharge area 102 within a debris bag (not show). In other examples, the outlet 118 is configured to deliver processed debris to discharge area 102 on the ground. In other examples still, the outlet 118 is configured to deliver processed debris to another machine, such as a wagon, conveyor, or other like machine that is configured to move the processed debris.

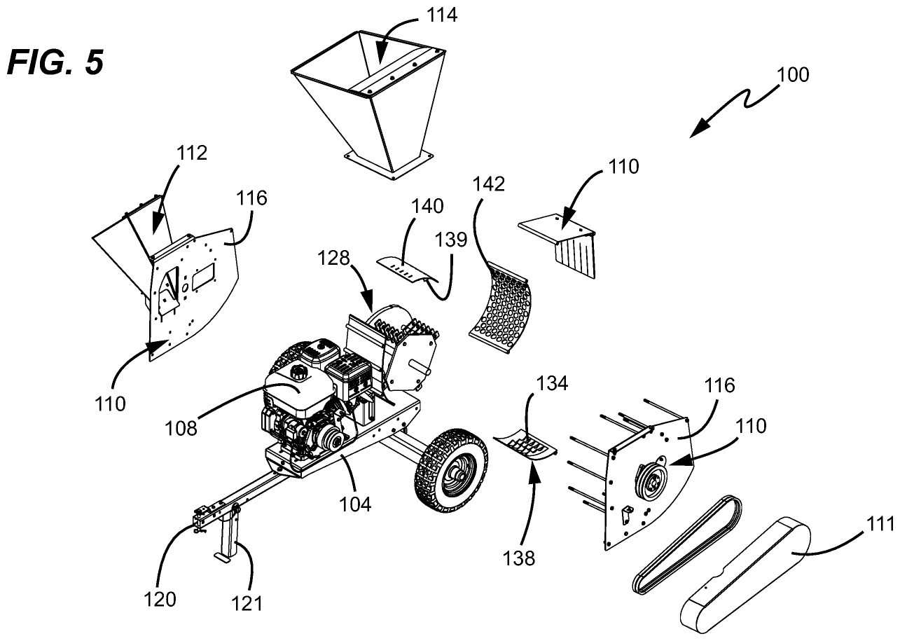

FIG. 5 shows an exploded view of the chipper shredder 100. As shown, the chipper shredder 100 includes a rotor assembly 128 positioned within a rotor chamber 130. During operation of the chipper shredder 100, the rotor assembly 128 rotates within the rotor chamber 130.

The rotor assembly 128 is rotationally powered by the engine 108 and positioned within the rotor chamber 130. The rotor assembly 128 includes a plurality of reducing elements 132 that process and reduce debris received from the chipping and shredding inlets 112, 114. The reducing elements 132 include a plurality of free-swinging hammers 131 and a chipping disc 134. Processed debris leaves the rotor chamber 130 via the outlet 118.

The rotor chamber 130 is defined by walls 136, a first fin plate 138, a second fin plate 140, and a screen 142. The rotor chamber 130 is partially defined by rotor chamber housing 116. Portions (for example, the first and second fin plates 138, 140 and the screen 142) of the rotor chamber 130 can be removable to allow the operator the opportunity to replace certain portions for wear and/or a particular application.

The walls 136 aid in defining the rotor chamber 130 and help contain debris within the rotor chamber 130 until processed material is expelled from the rotor chamber 130 through the screen 142 and out of the outlet 118.

The first and second fin plates 138, 140 each include a plurality of fins 139 connected thereto. The fins 139 aid in processing debris within the rotor chamber 130. In some examples, the first and second fin plates 138, 140 are identical. In some examples, the rotor chamber 130 only includes a single fin plate. In some examples, the rotor chamber 130 includes more than two fin plates.

The screen 142 is configured to allow debris of a certain size to pass from the rotor chamber 130 and out of the outlet 118 of the chipper shredder 100 to the discharge area 102. In some examples, the screen 142 can be changed/replaced depending on wear and/or a particular application.

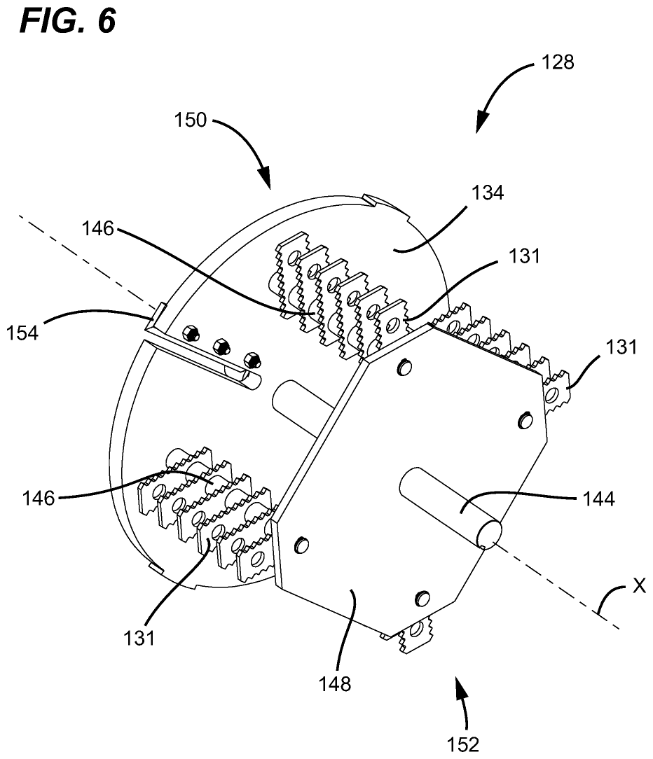

FIG. 6 shows a perspective view of the rotor assembly 128. It is considered within the scope of the present disclosure that the rotor assembly 128, and the components thereof, can have a variety of configurations.

The rotor assembly 128 includes the plurality of free-swinging hammers 131, the chipping disc 134, a central shaft 144, a plurality of auxiliary shafts 146, and an end plate 148. The rotor assembly 128 includes a first end 150 and a second end 152. The first end 150 is positioned adjacent the chipping inlet 112.

The plurality of free-swinging hammers 131 are configured to shred material within the rotor chamber 130. In some examples, the free-swinging hammers 131 can include a sharpened edge. In some examples, the free-swinging hammers 131 have a blunt edge. In some examples, the free-swinging hammers 131 have a serrated edge. The plurality of free-swinging hammers 131 can be replaceable/and or sharpened as needed.

The chipping disc 134 is mounted at the first end 150 of the rotor assembly 128. The chipping disc 134 includes at least one chipping knife 154 that is configured to create chips from a branch fed into the chipping inlet 112. In some examples, the chipping disc 134 can include a plurality of chipping knives 154.

The central shaft 144 defines a rotational axis X of the rotor assembly. In some examples, the central shaft 144 is driven by the motor 108. As shown, both the chipping disc 134 and the end plate 148 are connected to the central shaft 144 and rotate around the rotational axis X. The end plate 148 is also connected to the plurality of auxiliary shafts 146, thereby allowing the plurality of auxiliary shafts 146 to rotate around the rotational axis X.

The plurality of auxiliary shafts 146 each include a plurality of free-swinging hammers 131 mounted thereto. Each free-swinging hammer 131 is mounted to an auxiliary shaft and freely swings about that auxiliary shaft 146.

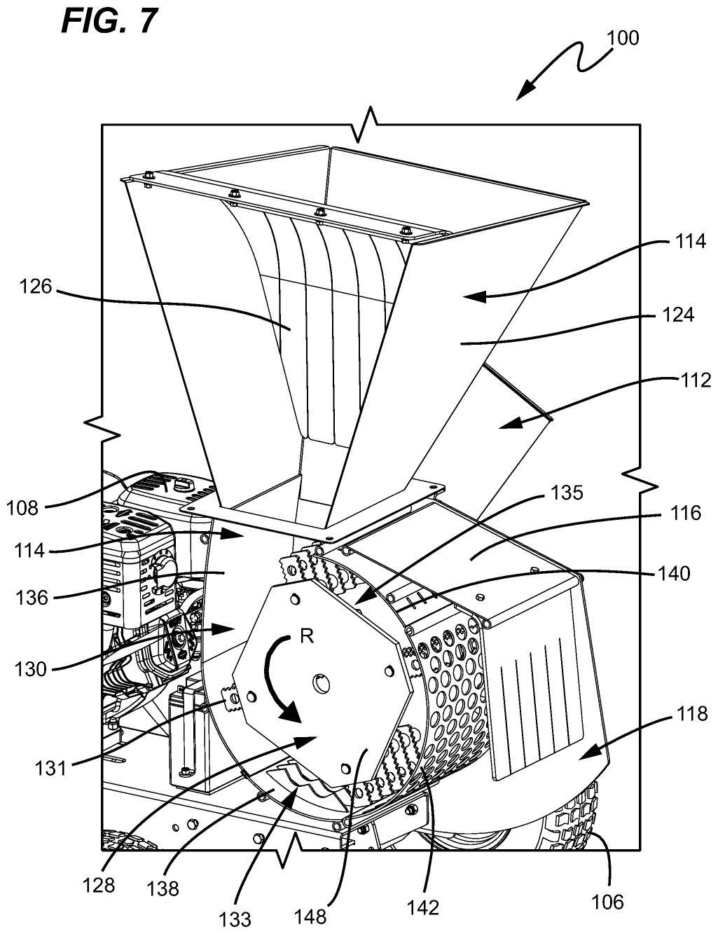

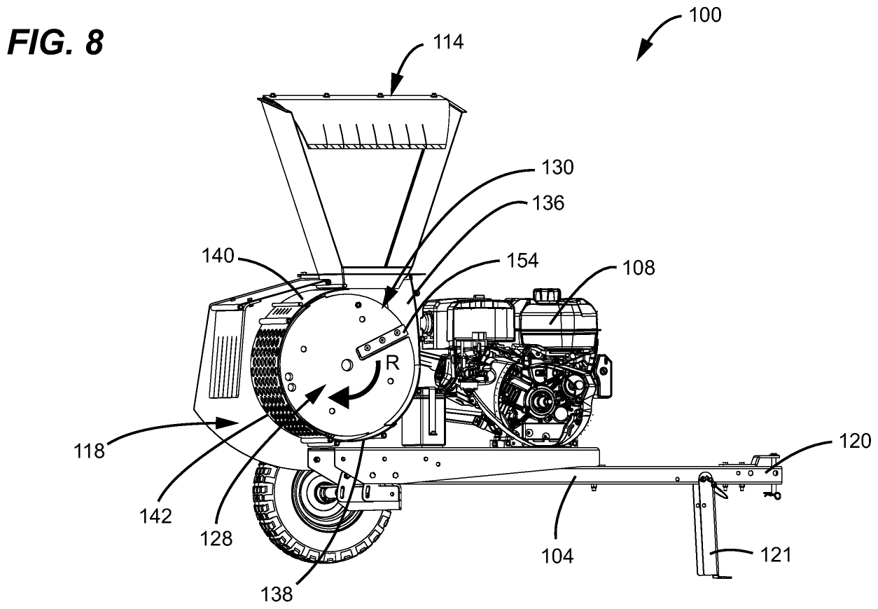

FIGS. 7 and 8 show perspective schematic views of the rotor chamber 130 of the chipper shredder 100. As shown, the shredding inlet 114 communicates with the rotor chamber 130 at an upper portion 135 of the rotor chamber 130, and the chipping inlet 112 communicates with a side portion 141 of the rotor chamber 130.

The rotor chamber 130 includes the wall 136 immediately adjacent the first fin plate 138. The first and second fin plates 138, 140 are immediately adjacent the screen 142. The first fin plate 138 is positioned at a lower portion 133 of the rotor chamber, while the second fin plate 140 is positioned at the upper portion 135 of the rotor chamber 130, adjacent the shredding inlet 114.

As debris is received via the chipping inlet 112, the debris first encounters the chipping disc 134 of the rotor assembly 128, and then encounters the plurality of free-swinging hammers 131 of the rotor assembly 128 within the rotor chamber 130. Debris then leaves the rotor chamber 130 by passing through the screen 142, passing through the outlet 118, and depositing at the discharge area 102.

As debris is received via the shredding inlet 114, debris first encounters the plurality of free-swinging hammers 131 of the rotor assembly 128 within the rotor chamber 130. Like debris received at the chipping inlet 112, debris leaves the rotor chamber 130 by passing through the screen 142, passing through the outlet 118, and depositing at the discharge area 102.

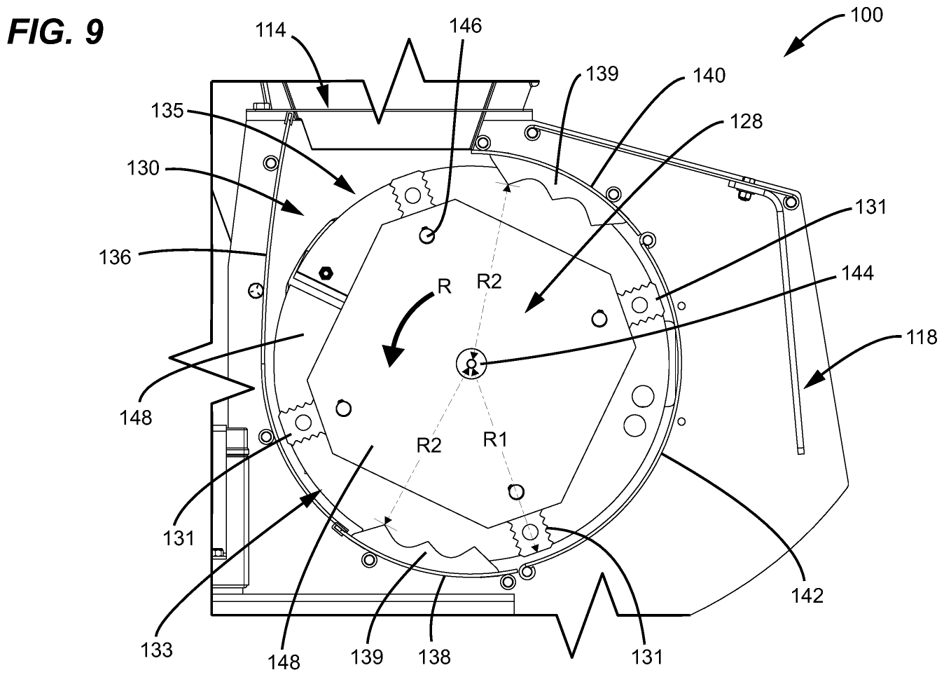

FIG. 9 shows a schematic side view of the rotor assembly 128 positioned within the rotor chamber 130. As shown, the fins 139 of the first and second fin plates 138, 140 extend into the rotor chamber 130. As shown in FIG. 7, the rotor assembly 128 has a rotation direction R that is clockwise. As shown in FIG. 8, the rotor assembly 128 has a rotation direction R that is counterclockwise.

Debris within the rotor chamber 130 is contacted by the free-swinging hammers 131. Debris at the outer extents of the rotor chamber 130 first encounters the walls 136, then the fins 139 of the first fin plate 138, and then the screen 142. If debris is of a small enough size, the debris travels through the screen 142 and out of the rotor chamber 130 to outlet 118. If debris is not small enough to exit the rotor chamber 130 through the screen 142, the rotation of the rotor assembly 128 can carry the debris upwardly so that the debris contacts the fins 139 of the second fin plate 140 at the upper side 135 of the rotor chamber 130. Debris can take a variety of different paths within the rotor chamber 130; however, the fins 139 of the first and second plates 138, 140 aid in preventing debris from building up and clogging the rotor chamber 130. Further, the fins 139 provide a non-moving static edge that works together with the moving rotor assembly 128 to reduce debris within the rotor chamber 130.

In some examples, the plurality of free-swinging hammers 131 extend a radial distance R1 from the rotational axis X of the rotor assembly 128. In some examples, the fins 139 of the first and second fin plates 138,140 extend into rotor chamber 130 so at least a portion of each fin 139 is positioned a radial distance R2 from the rotational axis X of the rotor assembly 128. In some examples, the radial distance R2 is less than the radial distance R1. This allows the plurality of the free-swinging hammers 131 to radially overlap at least a portion of the fins 139 during operation of the rotor assembly 128.

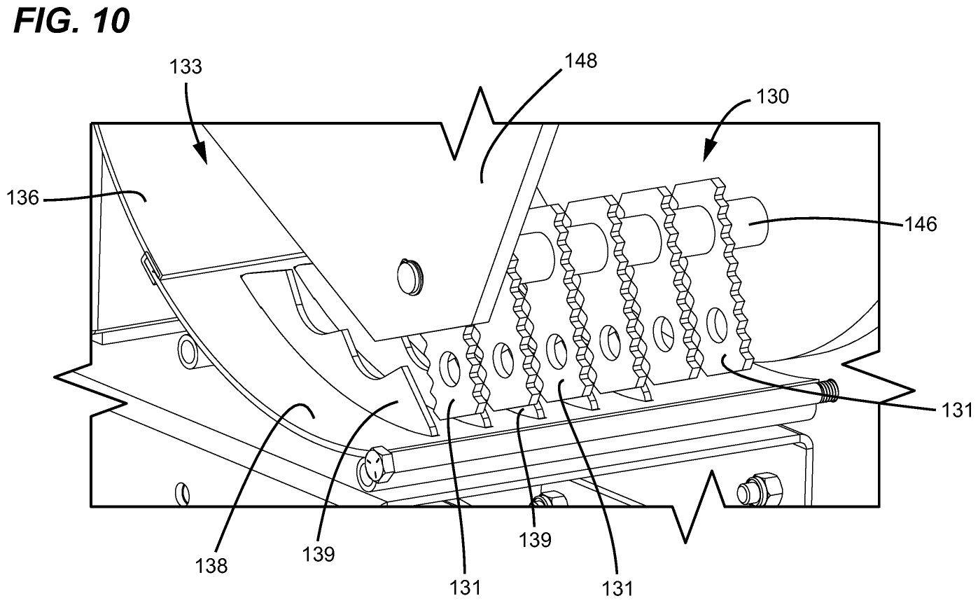

FIG. 10 shows a perspective view of a portion of the lower portion 133 of the rotor chamber 130 with rotor assembly 128. As depicted, the fins 139 radially overlap the plurality of free-swinging hammers 131 but are spaced about a main body 156 of the first fin plate 138 so as to not interfere with the plurality of free swinging hammers 131.

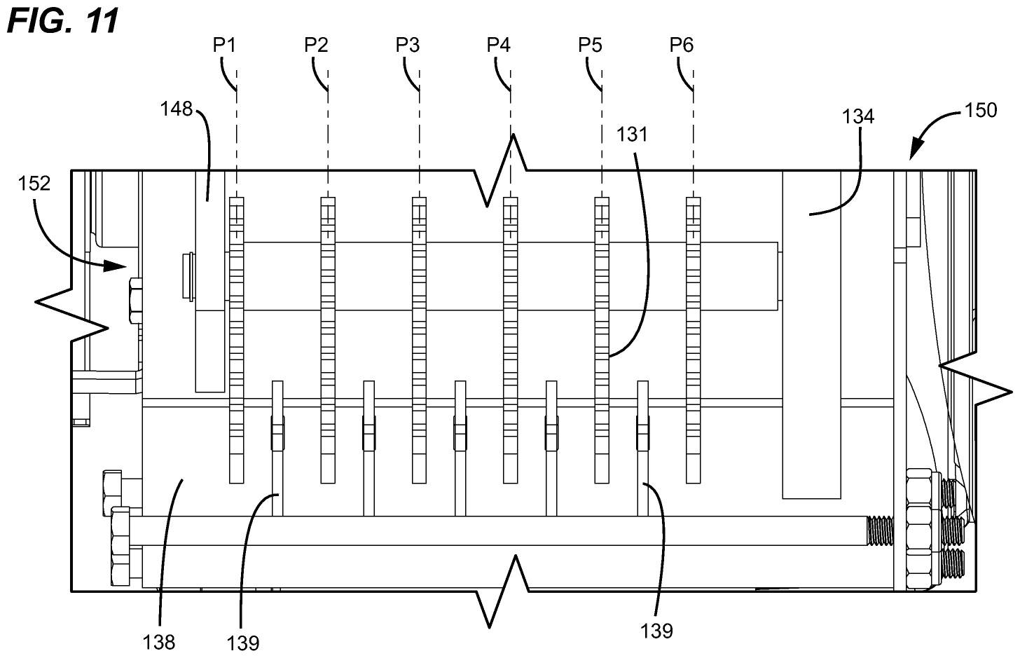

FIG. 11 shows a schematic view of a portion of the rotor assembly 128 and the rotor chamber 130. As shown, each free-swinging hammer 131 has a path of travel P1, P2, P3, P4, P5, and P6. As depicted, the fins 139 are spaced on the main body 156 of the first fin plate 138 so as to be positioned between the paths of travel P1-P6 of the plurality of free-swinging hammers 131. In some examples, a single fin 139 is positioned between paths of travel of adjacent free-swinging hammers 131. In some examples, more than one fin 139 is positioned between adjacent paths of travel of free-swinging hammers 131. In some examples, a single fin 139 is positioned between paths of travel adjacent free-swinging hammers 131. While only the first fin plate 138 is depicted, the second fin plate 140 can have substantially similar construction as the first fin plate 138.

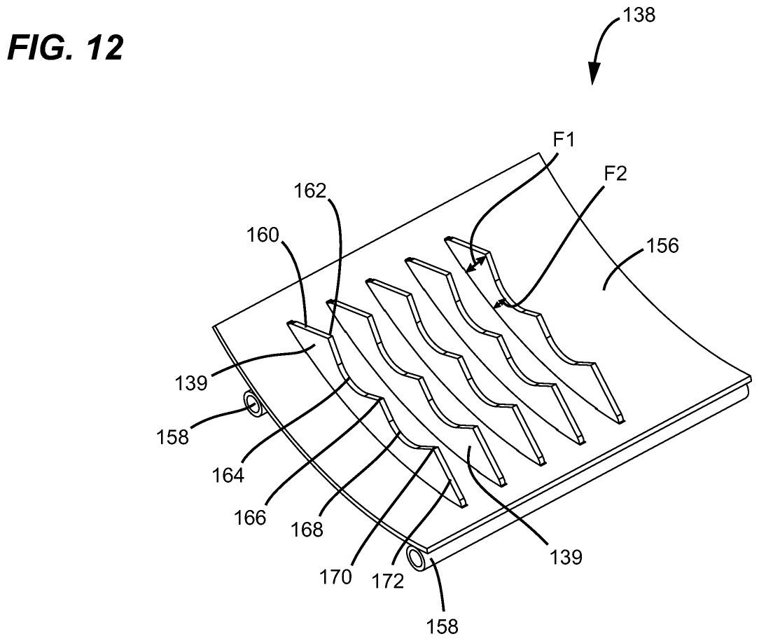

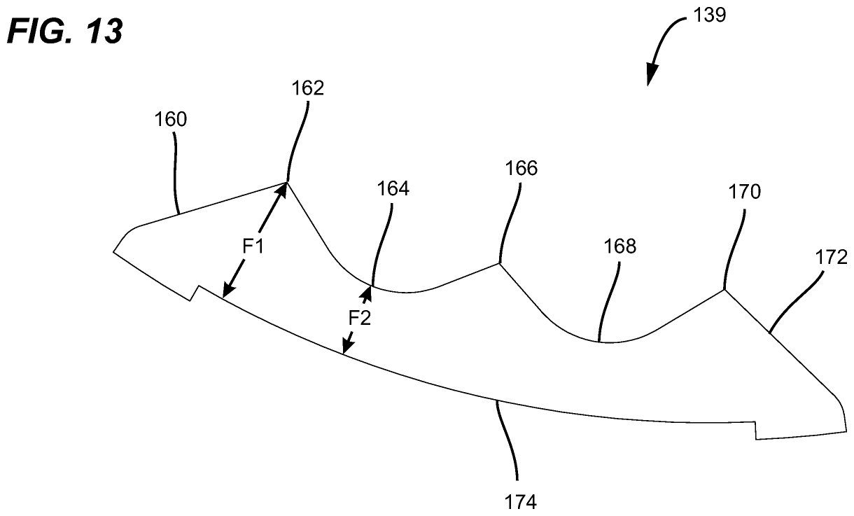

FIG. 12 shows a perspective view of the first fin plate 138, and FIG. 13 shows a side view of a fin 139 removed from the main body 156. While only the first fin plate 138 is depicted, the second fin plate 140 can have substantially similar construction as the first fin plate 138. As shown, the first fin plate 138 includes five fins that extend away from the main body 156.

In some examples, the main body 156 has an arcuate construction that generally matches the shape of the rotor chamber 130. In other examples, the main body 156 has a generally planar construction. The main body 156 can include mounting features 158 that facilitate mounting the first fin plate 138 to the chipper shredder 100. In the depicted example, the mounting features 158 are cylinders configured to receive fasteners, such as bolts. In other examples, the mounting features 158 can include flanges that mate with corresponding flanges of the chipper shredder 100 to facilitate attaching the first fin plate 138 to the chipper shredder 100.

Due to the construction of the first fin plate 138, replacing the first fin plate 138 can be easily accomplished. For example, if a fin 139 becomes damaged by debris (e.g., a rock in the rotor chamber 130), the fin plate 138 can be easily removed and replaced without substantial downtime.

FIG. 13 shows a side view of a fin 139. The fin includes a ramped leading edge 160, a first fin point 162, a first fin valley 164, a second fin point 166, a second fin valley 168, a third fin point 170, and a ramped trailing edge 172. While shown in a particular configuration, it is considered within the scope of the present disclosure that the fin 139 can have a variety of different constructions.

The ramped leading edge 160 allows debris that comes into contact with the fin 139 to raise along the ramped leading edge 160 toward the trailing edge 172, in the direction of rotation R of the rotor assembly 128. Such a configuration helps to prevent debris from building up against the leading edge of the fin 139 and thereby not proceeding over the fin 139, in the direction of rotation R.

The first fin point 162 is positioned between the leading edge 160 and the first fin valley 164. The second fin point is positioned between the first fin valley 164 and the second fin valley 168. The third fin point 170 is positioned between the second fin valley 168 and the ramped trailing edge 172. In some examples, the fin 139 can include less than three fin points. In some examples, the fin 139 can include more than three fin points.

As shown in FIG. 12, the fin points 162, 166, 170 extend a greater distance F1 away from the main body 156 than the distance F2 a lowest point of the fin valleys 164, 168 extends from the main body 156. Said another way, the fin points 162, 166, 170 extend a greater distance F1 away from a main body mounting side 174 of the fin 139 than the distance F2 a lowest point of the fin valleys 164, 168 extends from the main body mounting side 174.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

We claim:

1. A mobile chipper shredder comprising:
a frame including wheels mounted to the frame;
a motor mounted to the frame;
a chipping inlet for receiving debris to be chipped;
a shredding inlet for receiving debris to be shredded;
a rotor chamber in communication with the chipping inlet and the shredding inlet, the rotor chamber rotationally housing a rotor assembly powered by the motor, the rotor assembly including a chipping disc for receiving debris from the chipping inlet, and a plurality of free-swinging shredding hammers each having a path of travel as the rotor assembly rotates, the rotor chamber being defined by:
an inner wall;
a removable plate including:
a main body having an arcuate shape; and
a plurality of fins extending toward the rotor assembly from the main body, the fins being spaced on the main body so as to not interfere with the paths of travel of the free-swinging shredding hammers, wherein the plurality of fins radially overlap at least one path of travel of the plurality of free-swinging shredding hammers; and
an arcuate screen defining a plurality of apertures, wherein the apertures are sized and shaped to allow debris processed in the rotor chamber to pass therethrough; and
an outlet for receiving processed debris through the screen from the rotor chamber, the outlet being configured to deliver the processed debris to a discharge area external of the chipper shredder.

2. The mobile chipper shredder of claim 1, wherein the shredding inlet includes a hopper, and wherein the chipping inlet includes a chipper chute.

3. The mobile chipper shredder of claim 1, wherein each fin has a ramped leading edge leading to a fin point.

4. The mobile chipper shredder of claim 1, wherein each fin has a plurality of ramped edges and a plurality of fin points.

5. The mobile chipper shredder of claim 1, The mobile chipper shredder of any of claims 1-4, wherein each fin includes a ramped leading edge, a ramped trailing edge, at least three fin points, and at least one fin valley between adjacent fin points, wherein the fin points extend a greater distance away from the main body than the fin valleys.

6. The mobile chipper shredder of claim 1, wherein the frame includes a hitch to facilitate connecting the mobile chipper shredder to a tow hitch of a vehicle.

7. The mobile chipper shredder of claim 1, wherein the removable plate is a first removable plate, wherein the inner wall of the rotor chamber includes a second removable plate including:
a main body having an arcuate shape; and
a plurality of fins extending toward the rotor assembly from the main body, the fins being spaced on the main body so as to not interfere with the paths of travel of the free-swinging shredding hammers, wherein the plurality of fins radially overlap at least one path of travel of the plurality of free-swinging shredding hammers.

8. The mobile chipper shredder of claim 7, wherein the first and second removable plates are positioned immediately adjacent the screen.

9. The mobile chipper shredder of claim 7, wherein the first removable plate is positioned at a lower portion of the rotor chamber and the second removable plate is positioned at an upper portion of the rotor chamber.

10. The mobile chipper shredder of claim 1, wherein the shredding inlet is connected to an upper side of the rotor chamber.

11. The mobile chipper shredder of claim 1, wherein the chipping inlet is connected to a side of the rotor chamber adjacent the chipping disc of the rotor assembly.

12. The mobile chipper shredder of claim 1, wherein the rotor assembly includes a driven central shaft and a plurality of auxiliary shafts radially spaced from the central shaft, wherein the free-swinging shredding hammers are mounted to the auxiliary shafts.

13. The mobile chipper shredder of claim 1, wherein the plurality of fins is at least three fins.

14. The mobile chipper shredder of claim 1, wherein the plurality of fins is at least five fins.

15. A removable fin plate for use in a rotor chamber of a chipper shredder machine, the removable plate comprising:
a main body having an arcuate shape, the main body being configured to form a portion of the rotor chamber; and
a plurality of fins fixed to, and extending away from, the main body, the fins being spaced on the main body, wherein each fin has a ramped leading edge leading to a fin point.

16. The removable fin plate claim 15, wherein, when installed in a rotor chamber of chipper shredder, the fins are configured so as to not interfere with paths of travel of free-swinging shredding hammers, and wherein the plurality of the fins radially overlap at least one path of travel of the free-swinging shredding hammers.

17. The removable fin plate claim 15, wherein each fin has a plurality of ramped edges and a plurality fin points.

18. The removable fin plate claim 15, wherein each fin includes a ramped leading edge, a ramped trailing edge, at least three fin points, and at least one fin valley between adjacent fin points, wherein the fin points extend a greater distance away from the main body than a lowest point of the fin valleys.

19. The removable fin plate claim 15, wherein the plurality of fins is at least three fins.

20. The removable fin plate claim 15, wherein the plurality of fins is at least five fins.
